(19) United States
(12) Patent Application Publication
(10) Pub. No.: US 2018/0004175 A1
(43) Pub. Date: Jan. 4, 2018

(54) Heating Device Utilizing Computational or Processing Components

(71) Applicant: Thomas Halikias, New York, NY (US)

(72) Inventor: Thomas Halikias, New York, NY (US)

(21) Appl. No.: 15/625,248

(22) Filed: Jun. 16, 2017

Related U.S. Application Data
(60) Provisional application No. 62/356,228, filed on Jun. 29, 2016.

(51) Int. Cl. G05B 15/02; G05D 13/62

(52) U.S. Cl. CPC G05B 15/02; G05D 13/62

(57) ABSTRACT

A heating unit and a heating system are provided that utilize computational and/or processing components to generate and deliver varying levels of heat. The disclosed heating unit/system beneficially captures heat that is a byproduct of other activities, e.g., computing activities, for heating purposes. In addition, the disclosed heating unit/system may be connected to a broadband connection and the processing capabilities of the disclosed unit/system may be selectively used to engage a computing resource share market, e.g., a cryptocurrency “mining” system, to generate heat at a desired level while simultaneously generating revenue based on resource share market economies. Related methods for heat generation are also provided.

### CROSS-REFERENCE TO RELATED APPLICATION

The present application claims priority benefit to a provisional patent application entitled “A Heating Device Utilizing Computational or Processing Components,” which was filed on Jun. 29, 2016, and assigned Ser. No. 62/356,228. The entire content of the foregoing provisional application is incorporated herein by reference.

### TECHNICAL FIELD

The disclosure is directed to a heating unit or system that utilizes computational and/or processing components to generate and deliver varying levels of heat. Thus, the disclosed heating unit/system beneficially captures heat that is a byproduct of other activities, e.g., computing activities, for heating purposes. In addition, in exemplary embodiments of the present disclosure, the disclosed heating unit/system may be connected to a broadband connection and the processing capabilities of the disclosed unit/system may be selectively used to engage a computing resource share market, e.g., a cryptocurrency “mining” system, to generate heat at a desired level while simultaneously generating revenue based on resource share market economies.

### BACKGROUND ART

Space heating has proven to be an effective way to supplement a pre-existing heating system. By way of example, a standard space heater consumes 1500 watts of power per hour and produces 5100 BTUs of heat. Space heating can account for a large amount of energy consumption for residential consumers. It may consume more energy than other residential activities, such as cooking, refrigeration, and lighting. People are increasingly investing in space heaters to complement a centralized heating system and heat small areas.

Much like space heaters, computers utilize a significant amount of power and necessarily generate heat as an unavoidable byproduct. Power is defined in physics as the ability to do work, e.g., to physically move something or to generate heat. As electric current flows through a computer, heat is generated and this heat must be dissipated. Computers generate predictable quantities of heat, but the primarily focus in current systems is to dissipate such heat so as to avoid damage or overheat conditions with respect to the processing components. Typically, one or more fans are provided for this purpose.

The device, systems and methods of the present application advantageously harness the heat generated by computer systems and, in exemplary embodiments, connects to computing resource share market to simultaneously generate heat, e.g., to fulfill desired space heating objectives/requirements and benefit from the financial inducements/rewards associated with the computing resource share market. Additional features, functions and benefits of the disclosed devices, systems and methods will be apparent from the description which follows.

### SUMMARY

An object of this invention is to monetize the power required for supplemental heating. By utilizing specialized computer components in lieu of traditional heating elements, the systems/methods of the present disclosure can generate predetermined quantities of heat while performing computing tasks for compensation or expected compensation—many computational “share” processes are probabilistic in nature.

In accordance with exemplary embodiments of the present invention, a radiant electric space heater is provided that has a vented casing that allows for the distribution of heat generated by internal computer components. The heating unit typically offers either manual or automatic temperature controls that regulate the unit's heat dispersion by varying or limiting the use of the computational resources available within the unit. The heater has one or more internal fans which cool the unit and force heated air into the external environment.

The evolution of the computer “share” markets—e.g., shared computer storage and processing power—and the birth of cryptocurrencies and their required “mining”—i.e., proof-of-work or block validation—has created a means to monetize idle or strategic computer resources. The profitability of shared computing resources is highly correlated to the cost of electricity. By generating heat as a valuable byproduct of a device's or system's participation in a computing resource share market, the economics of such participation are advantageously improved for such participant. In addition, dual use of the processing capabilities of the disclosed device/system are “green” and support sustainability objectives.

The disclosed unit also provides for internet connectivity in order to access the computational “share” markets. The unit's internal computer mechanisms can be easily upgraded in order to keep pace with the evolution of available computational “share” resources.

Still another object of this invention is to provide, but not require, a means to optimize computational “share” market revenues. Units can connect to a central service that provides programming and allocates resources to the most lucrative “share” markets.

Other objects and advantages will become apparent from the following description and the drawing.

### BRIEF DESCRIPTION OF THE DRAWINGS

A more complete understanding of the present disclosure and advantages thereof may be acquired by referring to the following description in consideration with the accompanying drawings, in which like reference numbers indicate like features.

FIG. 1 is a schematic front view of an exemplary enclosure featuring computational components according to the present disclosure.

FIG. 2 illustrates a series of enclosures forwarding information to a computer share market and secondarily emitting heat, according to the present disclosure.

### DETAILED DESCRIPTION OF THE DRAWINGS

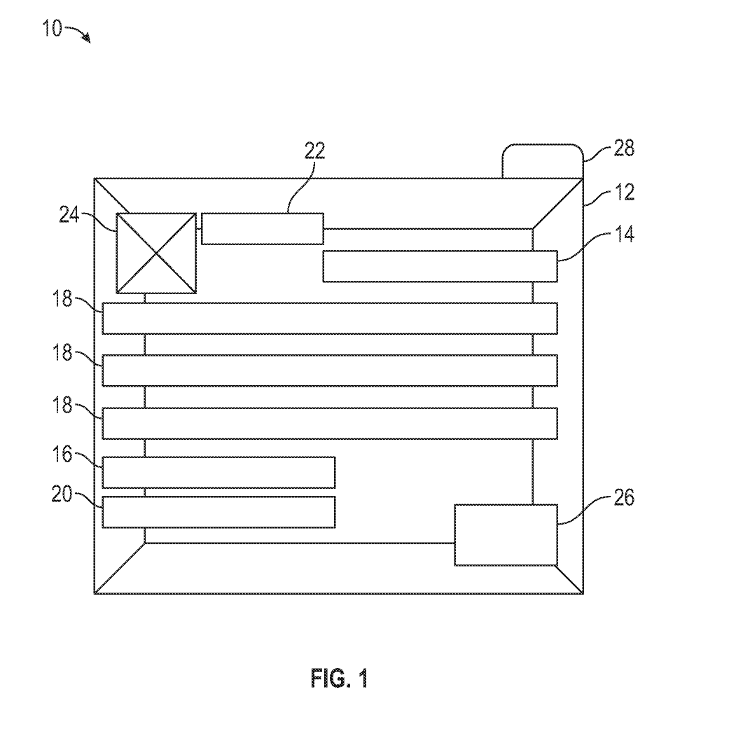

As referenced above, the present heating device features computational components as a controllable heat source, wherein the heating device can access a computer share market and, in exemplary embodiments, cryptocurrency economies as a means of supplementing the cost of producing heat. With reference to FIG. 1, heating device 10 includes enclosure 12 which houses various computational components. FIG. 1 is representative of the components that can be included in a computer; however, the location, quantity and type of computational components may vary, as will be apparent to persons skilled in the art.

Motherboard 14, commonly referred to as the logic board or mainboard, is a board with electrical circuits (not shown) printed on it that holds many of the computer's essential components. The electrical circuits (not shown) allow the components to receive power and communicate with each other. In one embodiment, processor (CPU) 16, graphics processing unit (GPU) 18, memory (RAM) 20 and network card 22 are all connected to motherboard 14. CPU 16 is the brain of the computer, wherein the processor typically performs two major tasks—performing mathematical and logical operations, and retrieving and carrying out instructions from the computer's memory 20. RAM 20 is a type of computer memory that is used for short-term data storage. Commonly, RAM 20 is an integrated circuit board installed in the motherboard 14. Graphics processing unit 18, commonly referred to as a video card, processes and outputs images to the computer's monitor. Less expensive graphics cards 18 are integrated directly into the motherboard 14, however, more powerful graphics cards 18 are a separate component that “plugs into” motherboard 14. Network card 22 or a network interface card, enables the computer to connect to the network.

Further, enclosure 12 also houses fan 24, for cooling internal components and distributing heat externally, power supply 26 and cord (not shown), wherein power supply 26 manages the power provided by an external source, through the cord, and distributes the power as required. External to enclosure 12 is control 28, which is a manual switch that turns the unit on and/or off and allows for adjustment of heating levels. In another embodiment, control 28 can be replaced and/or supplemented with a remote interface (not shown), for instance an app, which enables the user to remotely turn the unit on and/or off and allows for adjustment of heating levels. In another embodiment, control 28 can be installed within enclosure 12.

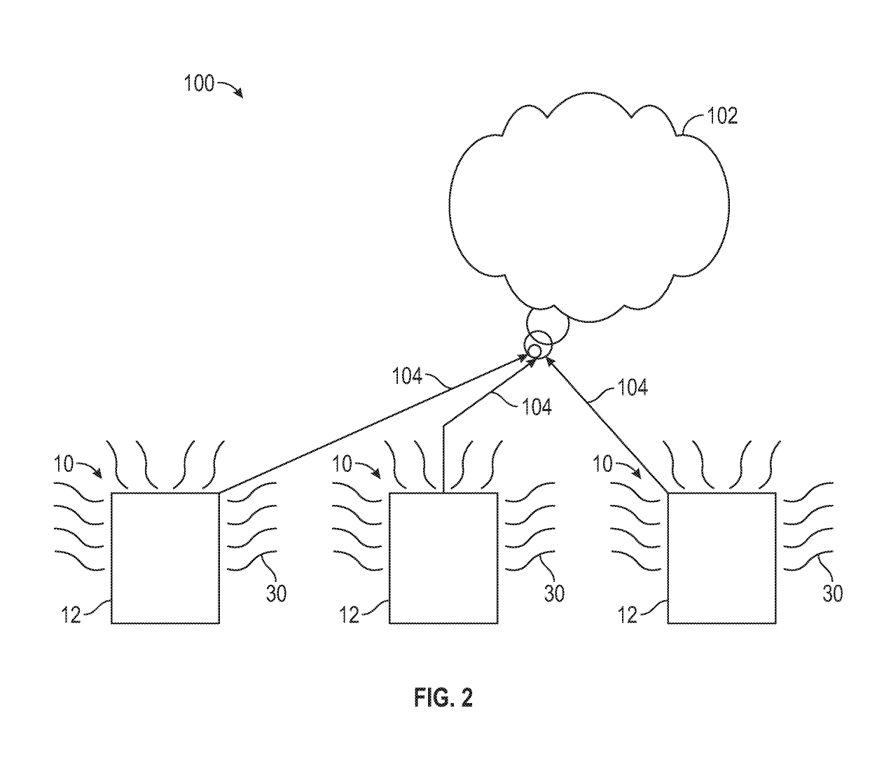

FIG. 2 illustrates network 100, wherein heating device 10 produces heat 30 and transmits data 104 to computer share market 102. In view of FIGS. 1 and 2, when operated, heating device 10 produces a controllable and predictable amount of heat that can be directed and distributed, via fan 24, to areas surrounding device 10, thereby supplementing and/or replacing current centralized heating sources. The heat produced can be manually controlled 28 (i.e., a dial or other mechanical interface) and/or by an automatic temperature control that senses the external room temperature and regulates the heat dispersion from device 10 by varying or limiting the use of the computational resources available within device 10.

As a means for reducing the operating costs and potentially generating positive financial benefit, heating device 10 is equipped with the components to access computer share market 102 and other cryptocurrency economies, therefore creating a revenue source. Specifically, device 10 is equipped with internet connectivity, via network card 22, thereby providing device 10 with access to the above-mentioned computer share markets. For example, heating device 10 may “mine” for cryptocurrency by computing/maintaining the public ledger (i.e., proof-of-work or block validation), as will be apparent to persons skilled in the art.

In brief, every cryptocurrency transaction is documented in a public ledger and, in order to ensure the public ledger is trustworthy and free of fraudulent transactions, the ledger must be maintained. The process of maintaining the public ledger requires many computers to connect to a single peer-to-peer network and each computer participate in a transaction-verifying process. In order to incentivize computers to participate, cryptocurrencies are periodically generated and awarded to the machines engaged in maintaining the ledger. See “Beginner's guide to mining Litecoin, Dogecoin, and other Bitcoin variants,” http://www.pcworld.com/article/2151261/beginners-guide-to-mining-litecoin-dogecoin-and-other-bitcoin-variants.html.

High-end computers are generally required to complete these “transaction-verifying” processes, as they are too demanding for traditional computers. As a result of the work, the computational components generate a significant amount of heat within enclosure 12. Traditionally, once the internal temperature of enclosure 12 reaches a predefined threshold, fan 24 is activated, wherein fan 24 extracts the warm air 30 from within enclosure 12 and disperses the warm air 30, through vents (not shown) of enclosure 12, and into the external area surrounding enclosure 12. In addition, warm air 30 being dispersed from enclosure 12 can also be used to heat the surrounding area. Consequently, fan 24 has accomplished two tasks, the first, cooling the internal components of enclosure 12 to avoid overheating and failure, and the second, providing a steady stream of warm air 30 into the surrounding area, thereby increasing the temperature of the surrounding area, wherein the surrounding area can be a residential room (i.e. bedroom, living room, home office, or the like) and/or a commercial room (i.e. office, data center, or the like). Although the figures depict a single fan 24, additional fans 24 can be included in order to facilitate the above-mentioned tasks, as will be apparent to persons skilled in the art.

Further, the amount of warm air 30 as well as the temperature of warm air 30 can be varied based on the user's requirements. For example, the run time of the computational components can be manipulated by control 28 in order to increase or decrease the internal temperature of enclosure 12. In addition, control 28 can operate fan 24 at varying speeds, to facilitate the dispersion of warm air 30 into the outer environment, based on the user's requirements. Much like a thermostat, control 28, or another remote device, can automatically sense the external temperature and adjust the parameters (i.e. internal air temperature and fan speed) to meet a predefined temperature. The internal and external temperature of enclosure 12 can be measured via a thermistor (not shown) or another sensing method. Additionally, device 10 can interface directly with the rooms current thermostat in order to sense the rooms temperature and adjust the parameters accordingly.

Although the present disclosure has been described with reference to exemplary embodiments and implementations thereof, the present disclosure is not limited by or to such exemplary embodiments/implementations. Rather, the devices, systems and methods disclosed herein may be modified, enhanced and/or refined without departing from the spirit or scope of the present disclosure.

1. A heating system, comprising:
a. computational components encased in an enclosure;
b. a power source in communication with the computational components to provide power thereto; and
c. a controller for controlling the computational components to generate a desired heat output by controlling the degree to which the computational components process data associated with a computing resource share market; and
wherein, as the computational components generate the desired heat output, the heat is dispersed to the external surrounding area.

2. The heating system according to claim 1, wherein the computational components are selected from the group consisting of a motherboard, a processor, a graphics processing unit, a memory, a network card, and combinations thereof.

3. The heating system according to claim 1, wherein the enclosure includes a fan for dispersing the desired heat output to the external surrounding area.

4. The heating system according to claim 1, wherein the controller controls the computational components based on temperature requirements.

5. The heating system according to claim 4, wherein the controller monitors a thermistor internal (in whole or in part) or external (in whole or in part) to the enclosure.

6. The heating system according to claim 4, wherein the controller automatically operates the computational components based on a predefined temperature threshold.

7. The heating system according to claim 1, wherein the controller controls the speed of the fan based on air flow requirements.

8. The heating system according to claim 1, wherein the controller is operated manually.

9. The heating system according to claim 1, wherein the controller is operated remotely.

10. The heating system according to claim 1, further comprising internet connectivity functionality associated with one or more of the computational components.

11. The heating system according to claim 10, wherein the internet connectivity functionality is adapted to access a computing resource share market.

12. The heating system according to claim 10, wherein the computing resource share market includes one or more systems associated with a currency and/or cryptocurrency economy.

13. The heating device according to claim 12, wherein the controller is adapted to mine for cryptocurrency.

14. A method of heating an area, comprising:
a. transmitting a request for heat to a controller associated with computational components;
b. controlling operation of the computational components to generate heat in response to the transmitted request at least in part based on processing associated with a computing resource share market; and
c. dispersing heat generated by the computational components to a surrounding area.

15. The method according to claim 14, wherein the computational components are selected from the group consisting of a motherboard, processor, graphics processing unit, memory, a network card, and combinations thereof.

16. The method according to claim 14, wherein the controller monitors a thermistor external to an enclosure encasing the computational components.

17. The method according to claim 14, wherein the controller automatically operates the computational components based on a predefined temperature threshold.

18. The method according to claim 14, wherein the controller controls the speed of a fan for dispersing the heat based on air flow requirements.

19. The method according to claim 14, wherein the controller is operated manually.

20. The method according to claim 14, wherein the controller is operated remotely.

21. The method according to claim 14, wherein the computational components are associated with internet connectivity functionality.

22. The method according to claim 21, wherein the computational components access computer share markets and/or cryptocurrency economies.

23. The method according to claim 21, wherein the device mines for cryptocurrency.
